(19) United States
(12) Patent Application Publication
(10) Pub. No.: US 2025/0236195 A1
(43) Pub. Date: Jul. 24, 2025

(54) Combination Power Replenishment System for Off-Grid and 100% Carbon Free Re-fueling Station for HYDROGEN Vehicles and Re-Charging Station for Electric Vehicles

(71) Applicants: William R. Selkirk, JR., Cambridge City, IN (US); Rebecca S. Selkirk, Cambridge City, IN (US); Donald Crawmer, Fortville, IN (US)

(72) Inventors: William R. Selkirk, JR., Cambridge City, IN (US); Rebecca S. Selkirk, Cambridge City, IN (US); Donald Crawmer, Fortville, IN (US)

(21) Appl. No.: 19/035,581

(22) Filed: Jan. 23, 2025

Related U.S. Application Data
(60) Provisional application No. 63/624,257, filed on Jan. 23, 2024.

(51) Int. Cl. B60L 53/57; B60L 53/16; B60L 53/51; B60L 53/54; F17C 5/00; F24S 10/70; H02J 15/00

(52) U.S. Cl. CPC B60L 53/57; B60L 53/16; B60L 53/51; B60L 53/54; F17C 5/007; F24S 10/70; H02J 15/008; F17C 2221/012; F17C 2270/0184

(57) ABSTRACT

An innovative Combination Power Replenishment System for Off-Grid and 100% Carbon Free Re-fueling Station for Hydrogen Vehicles with optional Re-Charging Station for Electric Vehicles and supplemental solar cells as an electrical source. The Power Replenishment System for Hydrogen Vehicles includes a Hydrogen Electrolyzer; a hydrogen fuel cell for obtaining hydrogen; a flow battery; at least one Hydrogen storage tank, a hydrogen pump, a hydrogen compressor, and a group of piping, valves, fixtures, and controls interconnecting the system; at least one hydrogen fueling pump distribution component; and optionally at least one electric vehicle charger port for an a Off-Grid, hydrogen-based re-fueling system by a pump and an at least 100% Carbon Free hydrogen Re-fueling Station and for HYDROGEN Vehicles and Re-Charging Station for Electric Vehicles.

### CROSS-REFERENCE TO RELATED APPLICATIONS

This application claims the benefit of U.S. Provisional Patent Application with Ser. No. 63/624,257 filed Jan. 23, 2024, by William R. Selkirk, Jr., Rebecca S. Selkirk, and Don Crawmer. The provisional application is entitled “A Combination Power Replenishment System for Off-Grid and 100% Carbon Free Re-fueling Station for HYDROGEN Vehicles and Re-Charging Station for Electric Vehicles”.

### FIELD OF INVENTION

This invention relates to a Combination Power Replenishment System for Off-Grid and 100% Carbon Free Re-fueling Station for HYDROGEN Vehicles and Re-Charging Station for Electric Vehicles. The present invention relates generally to fuel cell refueling stations, more particularly, to a hydrolyzer that is modified to additionally provide hydrogen and electricity dispensing stations to fuel cell vehicles. This invention relates to a fuel cell system for vehicles. The present invention relates to a hydrogen supply system and a hydrogen production system which are used for fuel cell powered automobiles and distributed fuel cell equipment as well as electric vehicle (EV) recharging. This invention relates to an energy network for providing hydrogen generated at an off-grid production site, particularly by one or more water electrolyzers, for use particularly, as a fuel for vehicles or energy storage. The invention further relates to the use of hydrogen as a fuel for a fuel cell wherein hydrogen can also be converted into electrical energy for the generation of electricity, particularly, as part of an off grid electrical distribution system. This disclosure relates to refueling, and, more particularly, to refueling a hydrogen vessel.

### FEDERALLY SPONSORED RESEARCH

None.

### SEQUENCE LISTING OR PROGRAM

None.

### BACKGROUND-FIELD OF INVENTION AND PRIOR ART

As far as known, there are no Combination Power Replenishment Systems for Off-Grid and 100% Carbon Free Re-fueling Station for HYDROGEN Vehicles and Re-Charging Station for Electric Vehicles, or the like. It is believed that this hydrogen-based system is unique in its design and technologies.

The present invention relates generally to fuel cell refueling stations, more particularly, to hydrogen dispensing stations for Fuel Cell Vehicles (FCV) and that are modified to additionally provide electricity to Electric Vehicles (EV) in an off-grid system that is 100% Carbon Free.

In order to protect the environment and air from harmful chemicals, the government has set maximum allowable harmful fuel emissions for vehicles in the United States. These requirements are forcing vehicle manufacturers to design vehicles that run on fuels other than gasoline and diesel fuel or consider alternative types of engines, such as electric engines. This has led to the design of vehicles that use fuel cells that run on pure hydrogen. When pure hydrogen is mixed with oxygen in the vehicle, water, heat, and electricity are produced, ideally without emitting other chemicals that are harmful to the air or the environment.

Fuel cell technology is so promising that several public-private partnerships have been formed between the U.S. Department of Energy (DOE) and the world's major automakers to promote the development of hydrogen as a primary fuel for cars and trucks. Among these groups, for example and not as a limitation, are: FreedomCAR (CAR stands for Cooperative Automotive Research), Alternative Fuels Data Center, Southwest Research Institute (SwRI), various laboratories such as National Renewable Energy Laboratory (NREL), a plethora of university research and development, and various studies by individual vehicle manufacturers such as Toyota, Hyundai, General Motors, Honda and others. These groups focus on technologies to enable mass production of affordable, hydrogen-powered fuel cell vehicles (FCV) as well as the hydrogen supply infrastructure to support them. While fuel cell vehicles are already being tested and used, a standard infrastructure that efficiently provides fuel for these vehicles throughout the country has not been fully developed yet.

Hydrogen is not found naturally and must be separated or stripped from a source chemical to obtain pure hydrogen. However, no general or absolute agreement exists as to which source chemical to use to obtain hydrogen. A number of different source chemicals are known, including natural gas (methane or CH₄), methanol, ethanol and even diesel fuel and gasoline. The expense of building the infrastructure depends heavily on which source chemical is used. The easiest way to build an infrastructure would be to modify the substantial existing gasoline and diesel fuel infrastructure to provide hydrogen at an off grid refueling station. Existing facilities could be fitted with devices for converting gasoline or diesel fuel to hydrogen. The fuel cell vehicles could then refuel at existing gas stations. Gasoline and diesel fuel, however, are very inefficient sources, providing merely 50% hydrogen for every pound of gasoline or diesel fuel. In addition, converting these fuels and purifying the hydrogen requires special low sulfuric chemicals, adding to the cost of the conversion.

Additionally, no consensus exists as to when to convert the source chemical into hydrogen along the process of supplying the hydrogen fuel. Hydrogen can be converted and purified at a plant and then supplied to the refueling stations (“upstream” conversion). However, supplying hydrogen to the refueling station can result in very high shipping costs because pure hydrogen is less dense or takes up more volume than hydrogen still bonded within the source chemicals. In other words, a tanker truck full of a source chemical will typically provide substantially more hydrogen than a tanker truck full of liquid hydrogen by itself. The hydrogen could also be produced by supplying the source chemical to the vehicle and providing mini plants on the vehicles for converting the source chemical to hydrogen on the vehicles (“downstream” conversion). This configuration, however, requires a reformer that strips the hydrogen from the source chemical on each vehicle.

Currently, fuel cell powered automobiles and distributed fuel cell equipment are now being developed actively. For example, hydrogen-mounted fuel cell powered automobiles use a principle that the mounted hydrogen is supplied to a fuel cell to obtain electricity, and a motor is rotated by the obtained electricity. Such a principal can be applied to all vehicles including not only automobiles running on four wheels but also motorcycles, trains running on rails, and the like. By the use of a system in which a fuel cell is used to operate a driving unit, high energy efficiency can be provided, and the emission of carbon dioxide (CO2) can be reduced, and the emission of nitrous oxides (Nox) can be almost eliminated, the emission of CO₂ and NOx posing a global environment problem. It is thought that a fuel cell powered automobile of a high-pressure hydrogen mounted type will be used widely for the time being. A big problem in widely using such fuel cell powered automobiles of a high-pressure hydrogen mounted type is to develop an infrastructure for hydrogen supply. In other words, there arises a problem of how a wide-area infrastructure for hydrogen supply is developed for fuel cell powered automobiles that run freely. As an infrastructure for hydrogen supply that is generally being developed at present, any of the following three methods can be used:

(1) Hydrogen is produced in large quantities at a factory etc., and it is transported to hydrogen supply stations in a form of liquefied hydrogen or high-pressure hydrogen by using a tank lorry or the like.

(2) Hydrogen is produced in large quantities at a factory etc., and it is transported to hydrogen supply stations with a pipeline.

(3) Hydrogen is produced by water-vapor reforming city gas or a liquid material (desulfurized naphtha, gasoline, kerosene, light oil, methanol, etc.) by using a reformer at a hydrogen station.

### Problem Solved

The improvement and problem solved as to Combination Power Replenishment Systems for Off-Grid and 100% Carbon Free Re-fueling Station for HYDROGEN Vehicles and Re-Charging Station for Electric Vehicles,

Problems addressed are:
1. Ultraviolet (UV) Thermal Solar Panel makes therms from the sun, even on cloudy cold days. The mass flow of hydrogen increases with increasing the temperature and concentration of electrolyte due to the high temperature decreases the potential required to rupture of the water molecule. Because of the heat, which is free, and it supplements the electrical load needed to make hydrogen from the electrolysis process.
2. Putting the Hydrogen Fuel Pump and EV Ports for charging vehicles is novel and unique as well.
3. Another novel and unique feature is the flow battery. We will be using sodium or magnesium flow battery. They last over 50 years and have no land-fill waste issues. When the EV chargers are not in use, the 500 kW Fuel cell will be charging the Flow Battery. When the Flow Batter is fully charged, it will power the electrolyzer as well to make more hydrogen.
4. Another novel and unique feature is it is 100% CARBON FREE and 100% OFF THE GRID.
5. See also the benefit tables for more problems eliminated or greatly reduced.

### PRIOR ART

As far as known, there are no Combination Power Replenishment System for Off-Grid and 100% Carbon Free Re-fueling Station for HYDROGEN Vehicles and Re-Charging Station for Electric Vehicles. A novelty search revealed:
A. A U.S. Pat. No. 6,908,700 was issued in 2005 to Iio and called a FUEL CELL SYSTEM FOR VEHICLE. This teaches a vehicle fuel cell system that comprises a controller that compares an input running distance to a predetermined distance. When the input running distance is less than the predetermined distance, the controller finishes running using only the hydrogen supplied from a hydrogen storage device without starting a start-up combustor. When the input running distance is larger than the predetermined distance, the controller starts the hydrogen supply from the hydrogen storage device, and simultaneously starts warm-up of a reformer by starting the start-up combustor.
B. A US Patent Application No. US 2006/0090399 provided in 2006 by Wikstrom et al and titled a FUEL CELL REFUELLNG STATION AND SYSTEM. This is a station for dispensing liquid natural gas (LNG) and hydrogen to vehicles features a bulk tank which receives LNG from a tanker truck. LNG from the bulk tank may be directed to either an LNG conditioning and dispensing portion of the station or a hydrogen production and dispensing portion of the station. The latter includes a heat exchanger for warming the LNG and a steam reformer which produces hydrogen and carbon dioxide from the warmed LNG. The hydrogen is compressed and then either stored or dispensed to a vehicle powered by a fuel cell. The carbon dioxide may optionally be further processed and stored for future use.
C. A US Patent Application No. US 2004/0049982 created by Shimizu et al in 2004 and named a HYDROGEN SUPPLY SYSTEM AND MOBILE HYDROGEN PRODUCTION SYSTEM. This provides a hydrogen supply system is configured so that a hydrogen supply station and a mobile hydrogen production system 1 are included, and hydrogen produced by the mobile hydrogen production system is supplied to the hydrogen supply station.
D. A U.S. Pat. No. 9,739,419 issued to Donnelly in 2017 and titled as a MULTI-FUEL SERVICE STATION. This demonstrates a method and system(s) are disclosed for integrating a new fuel into an operating transportation system in a continuous, seamless manner, such as diesel fuel being gradually replaced by compressed natural gas (“CNG”) in long haul trucks. Integration can be implemented using two enabling technologies. The first is an engine system capable of operating seamlessly on two or more fuels without regard to the ignition characteristics of the fuels. The second is a communications and computing system for implementing a fueling strategy that optimizes fuel consumption, guides the selection of fuel based upon location, cost and emissions and allows the transition from one fuel to another to appear substantially seamless to the truck driver.
E. A U.S. Pat. No. 6,745,105 issued in 2004 to Fairlie et al. and named an ENERGY DISTRIBUTION NETWORK. Taught is an energy distribution network is provided including an energy source; a hydrogen production facility connected to the energy source; a recipient for hydrogen from the hydrogen production facility; and a controller. The controller controls the production of hydrogen by the hydrogen production facility based on inputs including energy resource availability.
F. A U.S. Pat. No. 6,810,925 issued in 2004 to Graham et al and titled a HYDROGEN FUELING STATION. This provides a hydrogen fueling station and system for hydrogen fueled vehicles that can transfer any gaseous fuel to any vehicle and can be located in any place where a vehicle can park and where environmental, safety and other regulatory requirements permit gaseous fuel to be transferred. The hydrogen fueling station is vertically elongated and includes an enclosure that has a plurality of housings to house groups of like components. The housing is configured and positively ventilated with external air to prevent the accumulation of leaked hydrogen.
G. A US Patent Application No. US 2003/0146106 created by Mitlitsky in 2003 and titled a SYSTEM AND METHOD FOR REFUELLNG A HYDROGEN VESSEL. This is an electrochemical systems and methods of operating the systems are disclosed herein. In one embodiment, a method for operating an electrochemical system, comprises: forming hydrogen gas in an electrolysis cell, maintaining the hydrogen gas at a temperature sufficient to enable the filling of a hydrogen gas vessel at a rate that would fill a 5 kg vessel with the hydrogen gas in a period of time of less than or equal to about 10 minutes, and introducing the hydrogen gas to the hydrogen gas vessel.

As can be observed, none of the prior art has anticipated or caused one skilled in the art of Hydrogen refueling systems to anticipate this invention by the Selkirks. Likewise, a person of ordinary skill in the art (POSA) would not consider this hydrogen re-fueling system as obvious to a person skilled in the ordinary art of the industry. The Combination Power Replenishment System for Off-Grid and 100% Carbon Free Re-fueling Station for HYDROGEN Vehicles and Re-Charging Station for Electric Vehicles provides an answer to the need to readily have hydrogen gas available for vehicles to be replenished with hydrogen-based power through an onsite/in situ system. This system permits hydrogen as a replenishable energy to be available throughout a city, region, or country.

### SUMMARY OF THE INVENTION

This invention is a Combination Power Replenishment System for Off-Grid and 100% Carbon Free Re-fueling Station for HYDROGEN Vehicles and Re-Charging Station for Electric Vehicles. Taught here are the ways to distribute and to provide hydrogen as a viable energy for the propulsion of vehicles. The preferred embodiment of a Combination Power Replenishment System for Off-Grid and at least one hundred percent (100%) Carbon Free Re-fueling Station for Hydrogen Vehicles and Re-Charging Station for Electric Vehicles (EV) which is comprised of: (a) a Hydrogen Electrolyzer component; (b) a hydrogen fuel cell component using materials such as methanol, ethanol, anhydrous ammonium, and the like etc. for obtaining hydrogen; (c) a flow battery component using common host materials with water, the host materials coming from a host group of chemicals consisting of hydrogen rich chemicals [zinc-bromine, natural gas, alkaline fuel cell (AFC), Solid acid fuel cells (SAFCs), Phosphoric acid fuel cells (PAFCs), anhydrous ammonia, etc.] and water; (d) connection components including at least one Hydrogen storage tank, a hydrogen pump, a hydrogen compressor, and a group of piping, valves, fixtures, and controls interconnecting the group of fixtures and the components of the system; (e) at least one hydrogen fueling pump distribution component; and (f) at least one electric vehicle (EV) charger port wherein the Combination Power Replenishment System is for an a Off-Grid, hydrogen-based re-fueling system by a pump and an at least one hundred percent (100%) Carbon Free hydrogen Re-fueling Station and for HYDROGEN Vehicles and Re-Charging Station for Electric Vehicles (EV).

Putting the Hydrogen Fuel Pump, EV Ports and Ultraviolet (UV) Thermal Panels and EV Ports for charging vehicles is novel and unique as well. These are not present in any novelty or freedom to operate patent searches. Ultraviolet (UV) Thermal Solar Panels are supplemental sources of electricity. Solar thermal technology collects UV radiation from the sun and converts it into heat displacing the need for fossil fuels. This is not the same thing as photovoltaic solar panels, which create electricity. Use of a photovoltaic source is another option for the combination in a power replenishment system. Solar thermal collectors (panels) are placed on a roof, shade structure or other location absorb solar energy. Copper heating pipes transfer heat to the unit header and out of the thermal collector panel. Heat is conducted through a closed hydronic loop and into the building where it is delivered to a heat exchanger for direct use or to a storage tank. The solar-heated water is transferred to the end user through conventional boilers and water heaters precluding them from activating. This reduces the use of fossil fuels and emission of greenhouses gases and saves the user money on energy costs. They make therms from the sun, even on cloudy cold days. The mass flow of hydrogen increases with increasing the temperature and concentration of electrolyte due to the high temperature decreases the potential required to rupture of the water molecule. Because of the solar heat, which is free, it supplements and reduces the electrical load needed to make hydrogen from the electrolysis process. Another novel and unique feature is the flow battery. At present, the plan is to use a sodium or magnesium flow battery. They last over 50 years and have no land-fill waste issues. When the EV chargers are not in use, the 500 kW Fuel cell will be charging the Flow Battery. When the Flow Battery is fully charged, it will power the electrolyzer as well to make more hydrogen. Another novel and unique feature is it is 100% CARBON FREE and 100% OFF THE GRID.

### Objects and Advantages

There are several objects and advantages of the Combination Power Replenishment System for Off-Grid and 100% Carbon Free Re-fueling Station for HYDROGEN Vehicles and Re-Charging Station for Electric Vehicles. There are currently no known Carbon Free Re-fueling Station for HYDROGEN Vehicles that are effective at providing the objects of this invention. The Carbon Free Re-fueling Station for HYDROGEN Vehicles has various advantages and benefits:

| Item | Advantages |
|---|---|
| 1 | Is a highly efficient in using and generating |
| | hydrogen, making it a cost-effective solution as |
| | well as a low maintenance system. |
| 2 | Is a clean and renewable energy source. |
| 3 | Is a safe technology that does not produce harmful |
| | emissions. |
| 4 | Is versatile since it can be used in a variety of |
| | applications, making it a versatile technology |
| | that can be adapted to meet different needs. |
| 5 | Uses an abundantly renewable energy source making |
| | it a sustainable option. |
| 6 | Produces almost zero emissions |
| 7 | Reduces carbon footprint |
| 8 | Produces no noise pollution |
| 9 | Can be installed in remote or rural locations. |
| 10 | Converts a source chemical to pure hydrogen at a |
| | point, and with a source material, which reduces |
| | shipping costs and the cost to provide refueling |
| | stations to fuel vehicles. |
| 11 | Provides a relatively simple and inexpensive |
| | infrastructure with a refueling stations that |
| | converts a source chemical to pure hydrogen at an |
| | efficient high rate while substantially reducing |
| | waste material |

Finally, other advantages and additional features of the present Combination Power Replenishment System for Off-Grid and 100% Carbon Free Re-fueling Station for HYDROGEN Vehicles and Re-Charging Station for Electric Vehicles will be more apparent from the accompanying drawings and from the full description of the device. For one skilled in the art of hydrogen re-fueling system, it is readily understood that the features shown in the examples with this product are readily adapted to other types of fueling cells, hydrolyzers, and electrolysis systems and devices.

### BRIEF DESCRIPTION OF THE DRAWINGS—FIGURES

The accompanying drawings, which are incorporated in and constitute a part of this specification, illustrate an embodiment of a Carbon Free Re-fueling Station for HYDROGEN Vehicles that is preferred. The drawings together with the summary description given above and a detailed description given below act to explain the principles of the Combination Power Replenishment System for Off-Grid and 100% Carbon Free Re-fueling Station for HYDROGEN Vehicles and Re-Charging Station for Electric Vehicles. It is understood, however, that the Carbon Free Re-fueling Station for HYDROGEN Vehicles is not limited to only the precise arrangements and instrumentalities shown.

FIGS. 1 A through 1 D are sketches of the general Combination Power Replenishment System 30 for Off-Grid and 100% Carbon Free Re-fueling Station for HYDROGEN Vehicles and Re-Charging Station for Electric Vehicles.

FIG. 2 is a simplified sketch 33 of electricity sourced from renewable energy through hydrogen.

FIG. 3 is a Combination Power Replenishment System 30 for Off-Grid and 100% Carbon Free Re-fueling Station for HYDROGEN Vehicles and Re-Charging Station for Electric Vehicles with the components and features shown from generally a schematic of flow diagram.

FIGS. 4 A through 4 D are sketches of the Hydrogen (H2) hydrolyzer, fuel cell, and/or electrolysis unit 40 from a front view showing the Hydrogen distribution pump 60 for consumer 100 to add and replenish a vehicle with mor pressurized hydrogen and showing the Electrical Vehicle (EV) Charger 80 various Kilo Watts (KW) and connection ports.

FIG. 5 is a sketch from a top view of the Combination Power Replenishment System 30 for Off-Grid and 100% Carbon Free Re-fueling Station for HYDROGEN Vehicles and Re-Charging Station for Electric Vehicles with components of the unique combination identified.

FIG. 6 is an expanded sketch of the Combination Power Replenishment System 30 for Off-Grid and 100% Carbon Free Re-fueling Station for HYDROGEN Vehicles and Re-Charging Station for Electric Vehicles with additional features enabling a full-service power replenishment of gasoline and fossil fuel-based materials as well as the hydrogen-based system for renewable electricity.

FIG. 7 A through 7 D are sketches of Hydrogen Fuel Cells and Hydrolyzers.

FIG. 8 A through 8 C are sketches of the flow battery as a system to produce electricity for the Combination Power Replenishment System 30 for Off-Grid and 100% Carbon Free Re-fueling Stations.

FIGS. 9 A and 9 B are sketches of the fuel cells using hydrogen as the source for renewable electricity.

FIG. 10 A through 10 G are sketches of prior art.

### DESCRIPTION OF THE DRAWINGS—REFERENCE NUMERALS

The following list refers to the drawings:

### Table B: Reference Numbers

| Ref # | Description |
|---|---|
| 30 | A Combination Power Replenishment System 30 for |
| | Off-Grid and 100% Carbon Free Re-fueling Station |
| | for HYDROGEN Vehicles and Re-Charging Station Re- |
| | Charging Station for Electric Vehicles |
| 33 | Simplified sketch 33 of electricity from |
| | renewable energy through a hydrogen gas-based |
| | system |
| 35 | Combination 35 hydrogen gas distribution 30 with |
| | electrical charging stations 80 |
| 38 | Renewable energy 38 energy that comes from |
| | natural sources and can be used and developed |
| | with long term availability such as for example |
| | and not as a limitation wing, solar, vegetation |
| | sourced (ethanol has, etc. ), water and natural |
| | occurring elements (like hydrogen, oxygen, and |
| | their compounds (water), hydrogen 60 anhydrous |
| | ammonia, etc. |
| 40 | Hydrogen (H2) hydrolyzer, fuel cell, and/or |
| | electrolysis unit 40 |
| 42 | Hydrogen (H2) 42, compressed to various pressures |
| 43 | Methanol gas 43, compressed to various pressures |
| 44 | Hydrogen storage tanks 44 |
| 45 | Transportation tankers 45 for carrying compressed |
| | hydrogen 42 and methanol gas 43 or other |
| | compounds for fueling the hydrolyzers 40, fuel |
| | cells 70, and flow batteries 90 |
| 46 | Hydrogen carrying pipes, valves, and control |
| | system 46 |
| 47 | Optional low pressure hydrogen distribution |
| | piping, valves, and control system 47 |
| 48 | Electrolysis 48 |
| 50 | Hydrogen compressor 50 with ability to compress |
| | hydrogen gas to over 700 Bars |
| 55 | Hydrogen pump 55 |
| 60 | Hydrogen distribution pump 60 for consumer 100 to |
| | add and replenish a vehicle with mor pressurized |
| | hydrogen |
| 66 | Solar cells 66 - supplementary electrical source |
| 70 | Fuel Cell 70 |
| 71 | Department of Energy (DOE) sketch 71 of the |
| | chemistry and functioning of a Polymer |
| | Electrolyte Membrane Electrolyzer (PEM) type fuel |
| | cell |
| 73 | Wind based generator systems 73 |
| 75 | Electrical distribution wiring, power cables with |
| | controls 75 |
| 80 | Electrical Vehicle (EV) Charger 80 various Kilo |
| | Watts (KW) and connection ports |
| 90 | Flow Battery 90 (Off Peak, Fuel Cell 70 Charges |
| | Flow Battery 90 and when needed, Flow Battery 90 |
| | Charges the Electrolyzer 40 and/ or the fuel cell |
| | 70 |
| 95 | Schematic diagram 95 of how flow batteries 90 |
| | operate |
| 100 | Consumer, user 100 of fuel |
| 110 | Vehicle 110 |
| 120 | Traditional gasoline distribution pumps 120 |
| 130 | Traditional ethanol supplemented gasoline |
| | distribution pumps 130 |
| 140 | Traditional diesel fuel distribution pumps 140 |
| 150 | Traditional propane or LPG gas distribution pumps |
| | 150 |
| 160 | Future space/ zone for next generation vehicle |
| | power station pumps 160 - nuclear supplement, new |
| | source fuel cell, etc. |
| 200 | Big videos/ displays/ TV screens 200 for |
| | advertising and providing important news, |
| | information as to energy, financial reports, and |
| | road conditions in addition to standard |
| | advertising and mass media information. |
| 300 | prior Art 300 U.S. Pat. No. 6,908,700 - 2005 - BY Iio - |
| | FUEL CELL SYSTEM FOR VEHICLE |
| 310 | prior Art 310 Patent Application US 2006/0090399 - |
| | 2006 BY Wikstrom et al - FUEL CELL REFUELING |
| | STATION AND SYSTEM |
| 320 | prior Art 320 Patent Application US 2004/0049982 |
| | Shimizu et al - 2004 - HYDROGEN SUPPLY SYSTEM AND |
| | MOBILE HYDROGEN PRODUCTION SYSTEM |
| 330 | prior Art 330 U.S. Pat. No. 9,739,419 - Donnelly - |
| | 2017 |
| | MULTI - FUEL SERVICE STATION |
| 340 | prior Art 340 US Patent 6,745,105 - Fairlie et |
| | al. - 2004 -ENERGY DISTRIBUTION NETWORK |
| 360 | prior Art 350 US Patent 6, 810, 925 - Graham et al - |
| | 2004 -HYDROGEN fueling station |
| 360 | prior Art 360 US Patent Application US |
| | 2003/0146106 Mitlitsky - 2003 - SYSTEM AND METHOD |
| | FOR REFUELING A |
| | HYDROGEN WESSEL |

### DETAILED DESCRIPTION OF PREFERRED EMBODIMENT

This invention relates to a Combination Power Replenishment System for Off-Grid and 100% Carbon Free Re-fueling Station for HYDROGEN Vehicles and Re-Charging Station for Electric Vehicles. The present invention relates generally to fuel cell refueling stations, more particularly, to a hydrolyzer that is modified to additionally provide hydrogen and electricity dispensing stations to fuel cell vehicles. This invention relates to a fuel cell system for vehicles. The present invention relates to a hydrogen supply system and a hydrogen production system which are used for fuel cell powered automobiles and distributed fuel cell equipment as well as electric vehicle (EV) recharging. This invention relates to an energy network for providing hydrogen generated at an off-grid production site, particularly by one or more water electrolyzers, for use particularly, as a fuel for vehicles or energy storage. The invention further relates to the use of hydrogen as a fuel for a fuel cell wherein hydrogen can also be converted into electrical energy for the generation of electricity, particularly, as part of an off grid electrical distribution system. This disclosure relates to refueling, and, more particularly, to refueling a hydrogen vessel. The applications anticipate uses described and discussed below in the Operations Section.

Putting the Hydrogen Fuel Pump, EV Ports, and Ultraviolet (UV) Thermal Solar Panels for charging vehicles is novel and unique as well. These are not present in any novelty or freedom to operate patent searches. Ultraviolet (UV) Thermal Solar Panels are supplemental sources of electricity. They make therms from the sun, even on cloudy cold days. The mass flow of hydrogen increases with increasing the temperature and concentration of electrolyte due to the high temperature decreases the potential required to rupture of the water molecule. Because of the solar heat, which is free, it supplements and reduces the electrical load needed to make hydrogen from the electrolysis process. Solar thermal technology collects UV radiation from the sun and converts it into heat displacing the need for fossil fuels. This is not the same thing as photovoltaic solar panels, which create electricity. Photovoltaic solar panels are an option for supplemental energy. But solar thermal collectors (panels) on a roof, shade structure or other location absorb solar energy. Next, copper heating pipes transfer heat to the unit header and out of the thermal collector panel. The heat is conducted through a closed hydronic loop and into the building where it is delivered to a heat exchanger for direct use or to a storage tank. The solar-heated water is transferred to the end user through conventional boilers and water heaters precluding them from activating. So the UV system is Ultra Violet (UV) Thermal Solar Panels comprising (a) set of solar thermal collectors (panels) on a roof, shade structure or other location which absorb solar energy into a flow of water making a hot water; (b) copper heating pipes transfer heat to a unit header and out of the set of thermal collector panel; (c) a closed hydronic loop where the hot water is delivered to a heat exchanger for direct use or to a storage tank; and then (d) the solar-heated hot water is transferred to the end user through a conventional boiler and water heater for use. This reduces the use of fossil fuels and emission of greenhouses gases, and saves the user money on energy costs. Another novel and unique feature is the flow battery. C, the plan is to use a sodium or magnesium flow battery. They last over 50 years and have no land-fill waste issues. When the EV chargers are not in use, the 500 kW Fuel cell will be charging the Flow Battery. When the Flow Battery is fully charged, it will power the electrolyzer as well to make more hydrogen. Another novel and unique feature is it is 100% CARBON FREE and 100% OFF THE GRID.

The advantages for the Combination Power Replenishment System 30 for Off-Grid and 100% Carbon Free Re-fueling Station for HYDROGEN Vehicles and Re-Charging Station for Electric Vehicles are listed above in the introduction. Succinctly the benefits are that the device:
A. Is highly efficient in using and generating hydrogen, making it a cost-effective solution as well as a low maintenance system.
B. Is a clean and renewable energy source.
C. Is a safe technology that does not produce harmful emissions.
D. Is versatile since it can be used in a variety of applications, making it a versatile technology that can be adapted to meet different needs.
E. Uses an abundant renewable energy source making it a sustainable option.
F. Produces almost zero emissions
G. Reduces carbon footprint
H. Produces no noise pollution
I. Can be installed in remote or rural locations.
J. Converts a source chemical to pure hydrogen at a point, and with a source material, which reduces shipping costs and the cost to provide refueling stations to fuel vehicles.
K. Provides a relatively simple and inexpensive infrastructure with refueling stations that converts a source chemical to pure hydrogen at an efficient high rate while substantially reducing waste material.

The preferred embodiment is a Combination Power Replenishment System 30 for Off-Grid and at least one hundred percent (100%) Carbon Free Re-fueling Station 30 for Hydrogen Vehicles 110 and Re-Charging Station 80 for Electric Vehicles (EV) which is comprised of: (a) a Hydrogen Electrolyzer 40 component; (b) a hydrogen fuel cell 70 component using materials such as methanol, ethanol, anhydrous ammonium, and the like etc. for obtaining hydrogen; (c) a flow battery 90 component using common host materials with water, the host materials coming from a host group of chemicals consisting of hydrogen rich chemicals [zinc-bromine, natural gas, alkaline fuel cell (AFC), Solid acid fuel cells (SAFCs), Phosphoric acid fuel cells (PAFCs), anhydrous ammonia, etc.] and water; (d) connection components including at least one Hydrogen storage tank 44, a hydrogen pump 50, a hydrogen compressor 55, and a group 46 of piping, valves, fixtures, and controls interconnecting the group of fixtures and the components of the system 30; (e) at least one hydrogen fueling pump distribution component 55; and (f) at least one electric vehicle (EV) charger port 80 wherein the Combination Power Replenishment System 30 is for an a Off-Grid, hydrogen-based re-fueling system 60 by a pump 55 and an at least one hundred percent (100%) Carbon Free hydrogen Re-fueling Station 80 and for HYDROGEN Vehicles and Re-Charging Station for Electric Vehicles (EV).

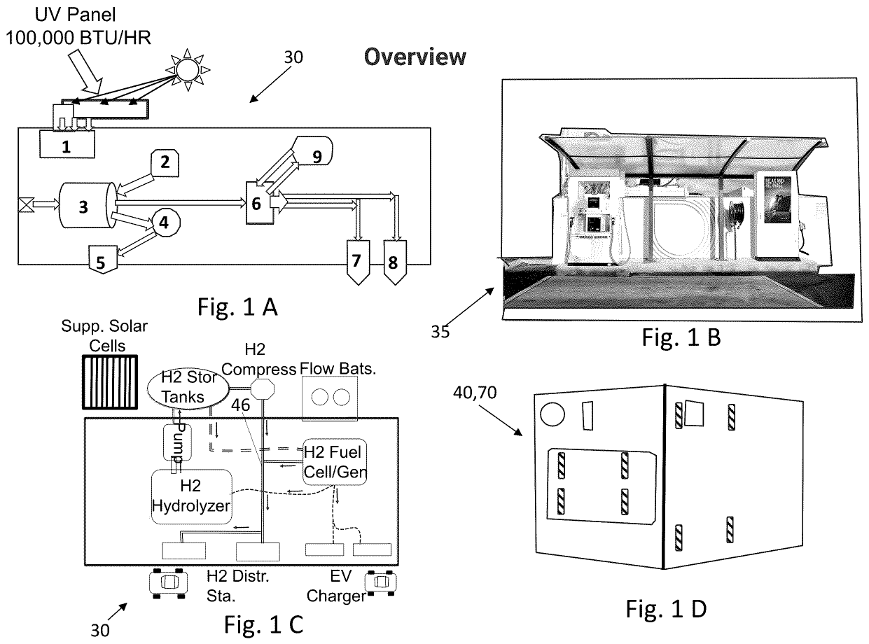

There is shown in FIGS. 1-10 a complete description and operative embodiment of the Combination Power Replenishment System for Off-Grid and 100% Carbon Free Re-fueling Station for HYDROGEN Vehicles and Re-Charging Station for Electric Vehicles. In the drawings and illustrations, one notes well that FIGS. 1-10 demonstrate the general configuration and use of this system. The various example uses are provided in the operation and use section, below.

The accompanying drawings, which are incorporated in and constitute a part of this specification, illustrate an embodiment of the Combination Power Replenishment System 30 for Off-Grid and 100% Carbon Free Re-fueling Station for HYDROGEN Vehicles and Re-Charging Station for Electric Vehicles that is preferred. The drawings together with the summary description given above and a detailed description given below explain the principles of the Carbon Free Re-fueling Station 30 for HYDROGEN Vehicles. It is understood, however, that System 30 is not limited to only the precise arrangements and instrumentalities shown. Other examples of hydrogen re-fueling systems and uses are still understood by one skilled in the art of hydrolyzers, fuel cells, electrolysis systems and the like to be within the scope and spirit shown here.

FIGS. 1 A through 1 D are sketches of the general Combination Power Replenishment System 30 for Off-Grid and 100% Carbon Free Re-fueling Station 55 for HYDROGEN Vehicles and Re-Charging Station 80 for Electric Vehicles. Shown in these sketches are: a Combination Power Replenishment System 30 for Off-Grid and 100% Carbon Free Re-fueling Station for HYDROGEN Vehicles and Re-Charging Station for Electric Vehicles; a combination 35 hydrogen gas distribution 30 with electrical charging stations 80; a hydrogen (H2) hydrolyzer, fuel cell, and/or electrolysis unit 40; and a Fuel Cell 70.

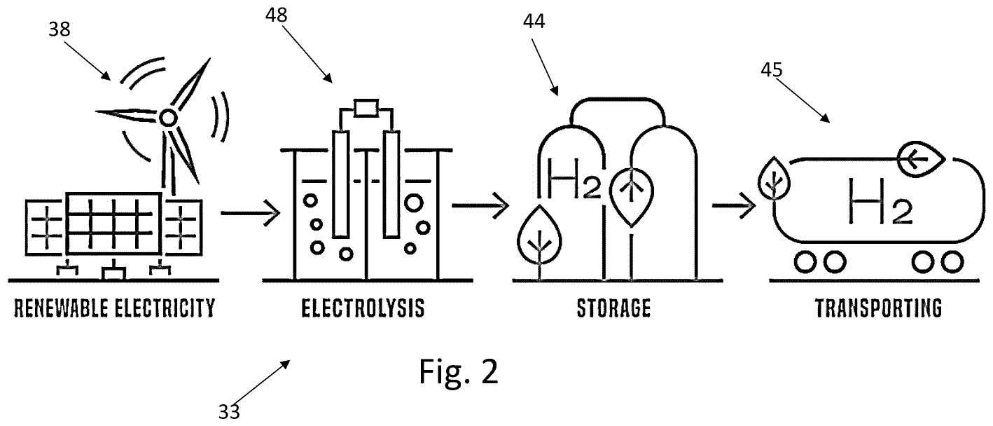

FIG. 2 is a simplified sketch 33 of electricity sourced from renewable energy through hydrogen. This figure directs a renewable mindset to electricity from renewable fuels and not depleting existing fossil fuels. Shown here are: a simplified sketch 33 of electricity from renewable energy through a hydrogen gas based system; a renewable energy 38 energy that comes from natural sources and can be used and developed with long term availability such as for example and not as a limitation wing, solar, vegetation sourced (ethanol has, etc.), water and natural occurring elements (like hydrogen, oxygen and their compounds (water), anhydrous ammonia, etc.; a hydrogen storage tanks 44; a transportation tankers 45 for carrying compressed hydrogen 42 and methanol gas 43 or other compounds for fueling the hydrolyzers 40, fuel cells 70, and flow batteries 90; and an electrolysis 48 system or device.

Renewable energy is energy derived from natural sources that are replenished at a higher rate than they are consumed. Sunlight and wind, for example, are such sources that are constantly being replenished. Renewable energy sources are plentiful and are all around us. Fossil fuels-coal, oil, and gas—on the other hand, are non-renewable resources that take hundreds of millions of years to form. Fossil fuels, when burned to produce energy, cause harmful greenhouse gas emissions, such as carbon dioxide. Generating renewable energy creates far lower emissions than burning fossil fuels. Transitioning from fossil fuels, which currently account for the lion's share of emissions, to renewable energy is key to addressing the climate crisis. Renewables are now cheaper in many countries and generate more jobs than fossil fuels. There are six major renewable energy sources:
1. Solar energy from the sun.
2. Geothermal energy from heat inside the earth.
3. Wind energy.
4. Biomass from plants.
5. Hydropower from flowing water.
6. Ocean energy

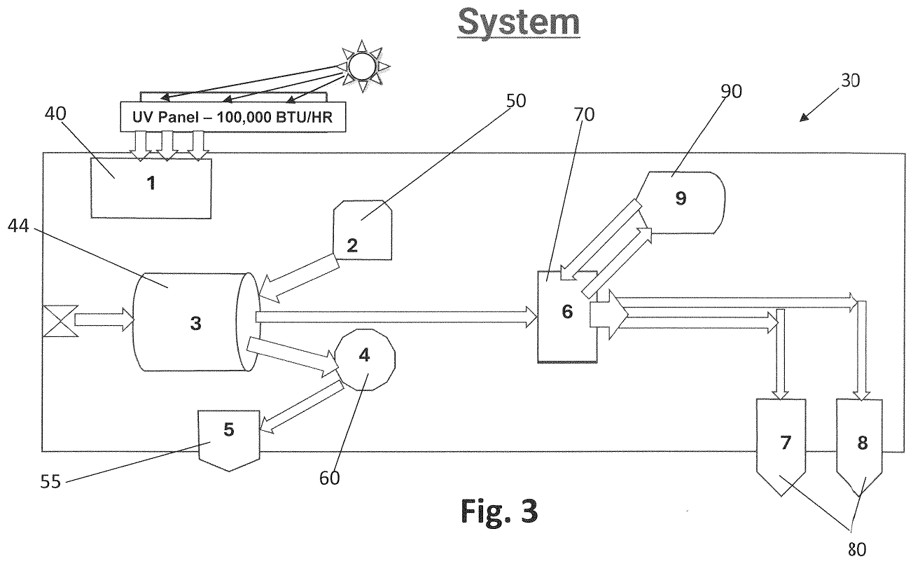

FIG. 3 is a Combination Power Replenishment System 30 for Off-Grid and 100% Carbon Free Re-fueling Station 55 for HYDROGEN Vehicles and Re-Charging Station 80 for Electric Vehicles with the components and features shown from generally a schematic of flow diagram. Demonstrated in this sketch are the main components for the Combination Power Replenishment System 30 for Off-Grid and 100% Carbon Free Re-fueling Station for HYDROGEN Vehicles and Re-Charging Station for Electric Vehicles; a hydrogen (H2) hydrolyzer, fuel cell, and/or electrolysis unit 40; a hydrogen (H2) 42, compressed to various pressures; a hydrogen storage tanks 44; a hydrogen carrying infrastructure of pipes, valves and control system 46; an optional low pressure hydrogen distribution piping, valves, and control system 47; an electrolysis 48 system or device; a hydrogen compressor 50 with ability to compress hydrogen gas to over 700 Bars; a hydrogen pump 55; a hydrogen distribution pump 60 for consumer 100 to add and replenish a vehicle with mor pressurized hydrogen; a Fuel Cell 70; an electrical distribution wiring, power cables with controls 75; an electrical Vehicle (EV) Charger 80 various Kilo Watts (KW) and connection ports; and a Flow Battery 90 (Off Peak, Fuel Cell 70 Charges Flow Battery 90 and when needed, Flow Battery 90 Charges the Electrolyzer 40 and/or the fuel cell 70. Language for drawing FIG. 3 is: Off the grid, 100% Carbon-Free Charging Station for Electric Vehicle (EV) and Hydrogen Powered FUEL CELLS.
1. Hydrogen Electrolyzer 40
2. H2 PUMP 99 50
3. H2 TANK 44
4. COMPRESSOR 60
5. H2 Fueling Pump 55 for vehicles 350 or 700 Bar
6. 500 KW H2 Fuel Cell 70
7. 180 KW EV CHARGER 80 2-PORTS
8. 180 KW EV CHARGER 80 2-PORTS
9. 750 KW Flow Battery 90 (Off Peak,
   Fuel Cell 70 Charges Flow Battery 90 and when needed, Flow Battery 90 Charges the Electrolyzer 40 and/or the fuel cell 70.

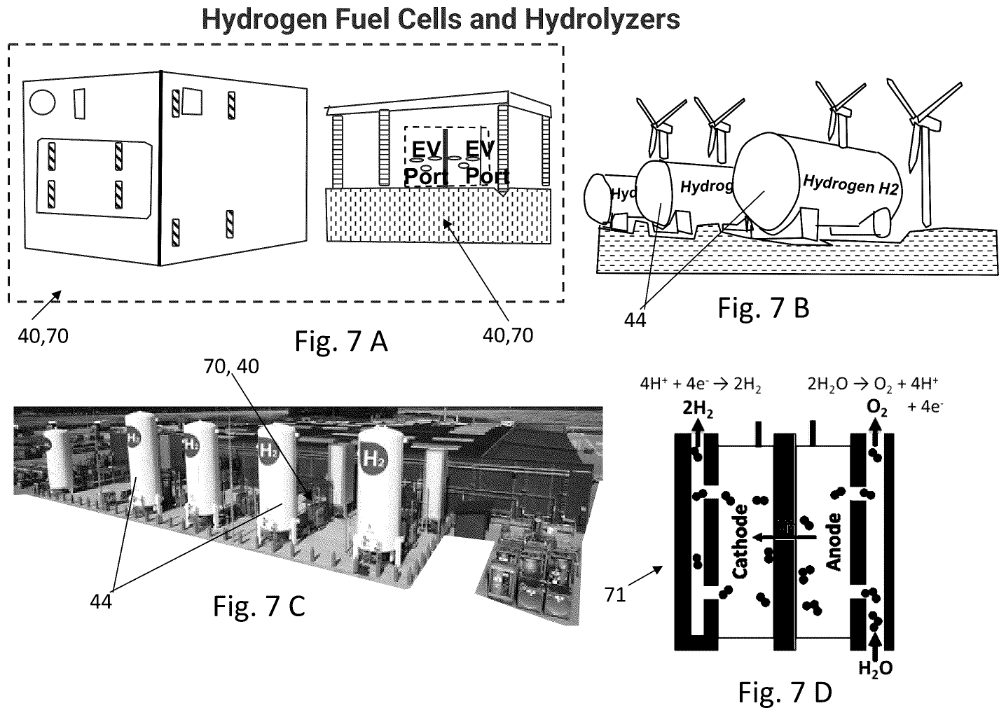

Electrolysis (see FIG. 7 D) is a promising option for carbon-free hydrogen production from renewable and nuclear resources. Electrolysis is the process of using electricity to split water into hydrogen and oxygen. This reaction takes place in a unit called an electrolyzer. Electrolyzers can range in size from small, appliance-size equipment that is well-suited for small-scale distributed hydrogen production to large-scale, central production facilities that could be tied directly to renewable or other non-greenhouse-gas-emitting forms of electricity production.

A hydrogen electrolyzer is an electrochemical device that consumes electrical power to split water into hydrogen and oxygen. Hydrogen electrolyzers are used for hydrogen production and are considered as part of a green energy production-storage distribution system when combined with a renewable power source, a hydrogen tank, and fuel cell systems such as fuel cell electric vehicles.

The three main types of hydrogen electrolyzers-alkaline, polymer electrolyte membrane (PEM), and solid oxide-focus on differences in electrolyte materials. A PEM hydrogen electrolyzer decomposes water using a semipermeable membrane that allows proton transport and blocks the electron flow. Because of this characteristic, this kind of hydrogen electrolyzer is also known as a proton exchange membrane electrolyzer.

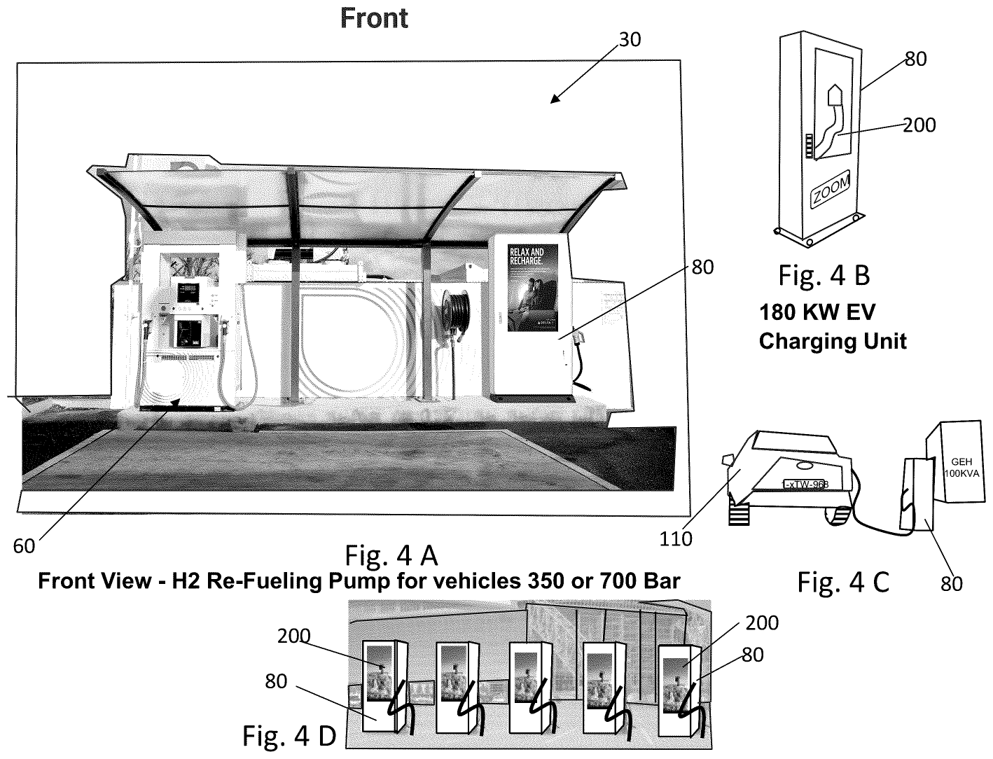

FIGS. 4 A through 4 D are sketches of the Hydrogen (H2) hydrolyzer, fuel cell, and/or electrolysis unit 40 from a front view showing the Hydrogen distribution pump 60 for consumer 100 to add and replenish a vehicle with mor pressurized hydrogen and showing the Electrical Vehicle (EV) Charger 80 various Kilo Watts (KW) and connection ports. Shown here are: a Combination Power Replenishment System 30 for Off-Grid and 100% Carbon Free Re-fueling Station for HYDROGEN Vehicles and Re-Charging Station for Electric Vehicles; a combination 35 hydrogen gas distribution 30 with electrical charging stations 80; a hydrogen distribution pump 60 for consumer 100 to add and replenish a vehicle with mor pressurized hydrogen; a solar cells 66—supplementary electrical source; an electrical Vehicle (EV) Charger 80 various Kilo Watts (KW) and connection ports; a vehicle 110; and a group of big video/displays/TV screens 200 for advertising and providing important news, information as to energy, financial reports and road conditions in addition to standard advertising and mass media information.

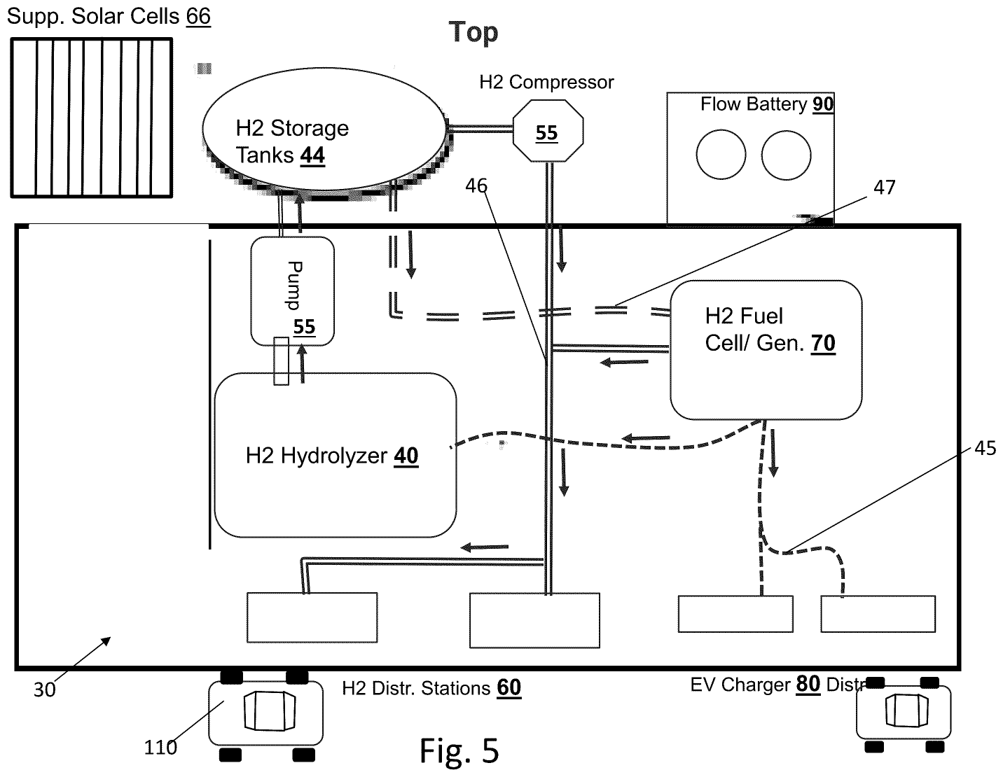

FIG. 5 is a sketch from a top view of the Combination Power Replenishment System 30 for Off-Grid and 100% Carbon Free Re-fueling Station for HYDROGEN Vehicles and Re-Charging Station for Electric Vehicles with components of the unique combination identified. Demonstrated here are: a Combination Power Replenishment System 30 for Off-Grid and 100% Carbon Free Re-fueling Station for HYDROGEN Vehicles and Re-Charging Station for Electric Vehicles; a hydrogen (H2) hydrolyzer, fuel cell, and/or electrolysis unit 40; a hydrogen (H2) 42, compressed to various pressures; a methanol gas 43, compressed to various pressures; a hydrogen storage tanks 44; a transportation tankers 45 for carrying compressed hydrogen 42 and methanol gas 43 or other compounds for fueling the hydrolyzers 40, fuel cells 70, and flow batteries 90; a hydrogen carrying pipes, valves and control system 46; an optional low pressure hydrogen distribution piping, valves, and control system 47; an electrolysis 48 system or device; a hydrogen compressor 50 with ability to compress hydrogen gas to over 700 Bars; a hydrogen pump 55; a hydrogen distribution pump 60 for consumer 100 to add and replenish a vehicle with mor pressurized hydrogen; a solar cells 66—supplementary electrical source; a Fuel Cell 70; an electrical distribution wiring, power cables with controls 75; an electrical Vehicle (EV) Charger 80 various Kilo Watts (KW) and connection ports; a Flow Battery 90 (Off Peak, Fuel Cell 70 Charges Flow Battery 90 and when needed, Flow Battery 90 Charges the Electrolyzer 40 and/or the fuel cell 70; and a vehicle 110.

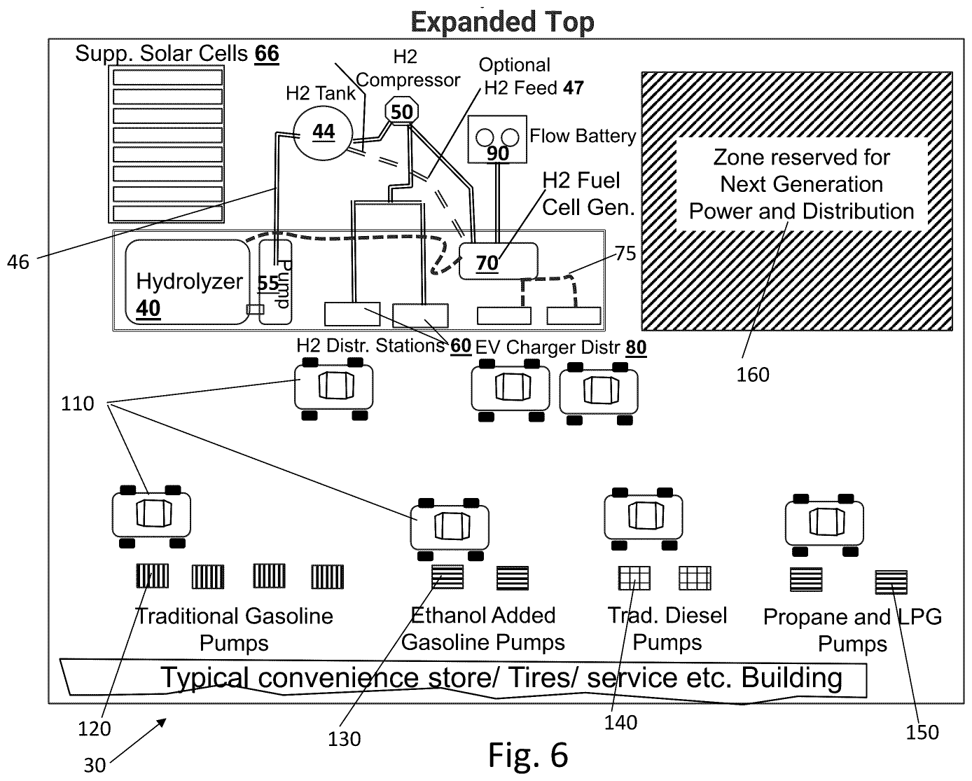

FIG. 6 is an expanded sketch of the Combination Power Replenishment System 30 for Off-Grid and 100% Carbon Free Re-fueling Station for HYDROGEN Vehicles and Re-Charging Station for Electric Vehicles with additional features enabling a full-service power replenishment of gasoline and fossil fuel-based materials as well as the hydrogen-based system for renewable electricity. This shows an all-encompassing power distribution system with gasoline, diesel, ethanol, liquid pressured gas; hydrogen, electricity, and even future space for other fuels undefined or developed at this time. It could anticipate providing nuclear energy sources as well. Shown here are: a Combination Power Replenishment System 30 for Off-Grid and 100% Carbon Free Re-fueling Station for HYDROGEN Vehicles and Re-Charging Station for Electric Vehicles; a hydrogen (H2) hydrolyzer, fuel cell, and/or electrolysis unit 40; a hydrogen (H2) 42, compressed to various pressures; a methanol gas 43, compressed to various pressures; a hydrogen storage tanks 44; a transportation tankers 45 for carrying compressed hydrogen 42 and methanol gas 43 or other compounds for fueling the hydrolyzers 40, fuel cells 70, and flow batteries 90; a hydrogen carrying pipes, valves and control system 46; an optional low pressure hydrogen distribution piping, valves, and control system 47; an electrolysis 48 system or device; a hydrogen compressor 50 with ability to compress hydrogen gas to over 700 Bars; a hydrogen pump 55; a hydrogen distribution pump 60 for consumer 100 to add and replenish a vehicle with mor pressurized hydrogen; a solar cells 66—supplementary electrical source; a Fuel Cell 70; an electrical distribution wiring, power cables with controls 75; an electrical Vehicle (EV) Charger 80 various Kilo Watts (KW) and connection ports; a Flow Battery 90 (Off Peak, Fuel Cell 70 Charges Flow Battery 90 and when needed, Flow Battery 90 Charges the Electrolyzer 40 and/or the fuel cell 70; and a vehicle 110. In addition, it shows a traditional gasoline distribution pumps 120; a traditional ethanol supplemented gasoline distribution pumps 130; a traditional diesel fuel distribution pumps 140; a traditional propane or LPG gas distribution pumps 150; and a future space/Off-Grid zone for next generation vehicle power station pumps 160—nuclear supplement, new source fuel cell, etc.

FIG. 7 A through 7 D are sketches of Hydrogen Fuel Cells 70 and Hydrolyzers 40. Pictured here are components for the Combination Power Replenishment System 30 for Off-Grid and 100% Carbon Free Re-fueling Station for HYDROGEN Vehicles and Re-Charging Station for Electric Vehicles including: a hydrogen (H2) hydrolyzer, fuel cell, and/or electrolysis unit 40; a hydrogen storage tanks 44; a Fuel Cell 70; and a Department of Energy (DOE) sketch 71 of the chemistry and functioning of a Polymer Electrolyte Membrane Electrolyzer (PEM) type fuel cell. How Does it Work? Like fuel cells, electrolyzers consist of an anode and a cathode separated by an electrolyte. Different electrolyzers function in different ways, mainly due to the different types of electrolyte material involved and the ionic species it conducts. In a polymer electrolyte membrane (PEM) electrolyzer, the electrolyte is a solid specialty plastic material. Water reacts at the anode to form oxygen and positively charged hydrogen ions (protons). The electrons flow through an external circuit and the hydrogen ions selectively moves across the PEM to the cathode. At the cathode, hydrogen ions combine with electrons from the external circuit to form hydrogen gas. Anode Reaction: 2H₂O→O₂+4H⁺+4e⁻ Cathode Reaction: 4H⁺+4e⁻→2H₂

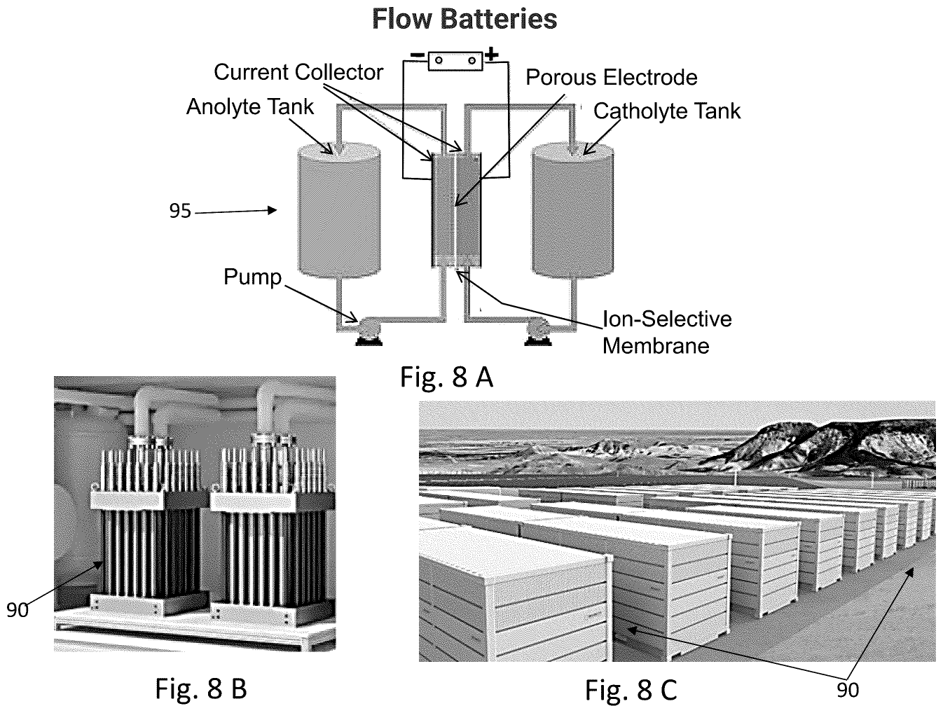

FIG. 8 A through 8 C are sketches of the flow battery as a system to produce electricity for the Combination Power Replenishment System 30 for Off-Grid and 100% Carbon Free Re-fueling Stations. Pictured here are even more components for the Combination Power Replenishment System 30 for Off-Grid and 100% Carbon Free Re-fueling Station for HYDROGEN Vehicles and Re-Charging Station for Electric Vehicles consisting of: a Flow Battery 90 (Off Peak, Fuel Cell 70 Charges Flow Battery 90 and when needed, Flow Battery 90 Charges the Electrolyzer 40 and/or the fuel cell 70 and a schematic diagram 95 of how flow batteries 90 operate.

Flow batteries are a unique green energy battery. Unlike lithium batteries, zinc-bromine flow batteries do not end up in landfills. That is because flow batteries have an almost limitless life cycle. How do flow batteries work? It begins with two tanks. Each tank has an active species. That activity could be a dissolved salt, supporting electrolytes, and a solvent like sulfuric acid. One tank is positive, and one tank is negative. Each tank flows into a cell tank that has an ionic membrane in the middle to keep them from mixing. As the solution flows out, one gets power. When it flows back it is charging. The energy is determined by the size of the tank. The power is determined by the size of the reactor located in the middle of the ionic membrane.

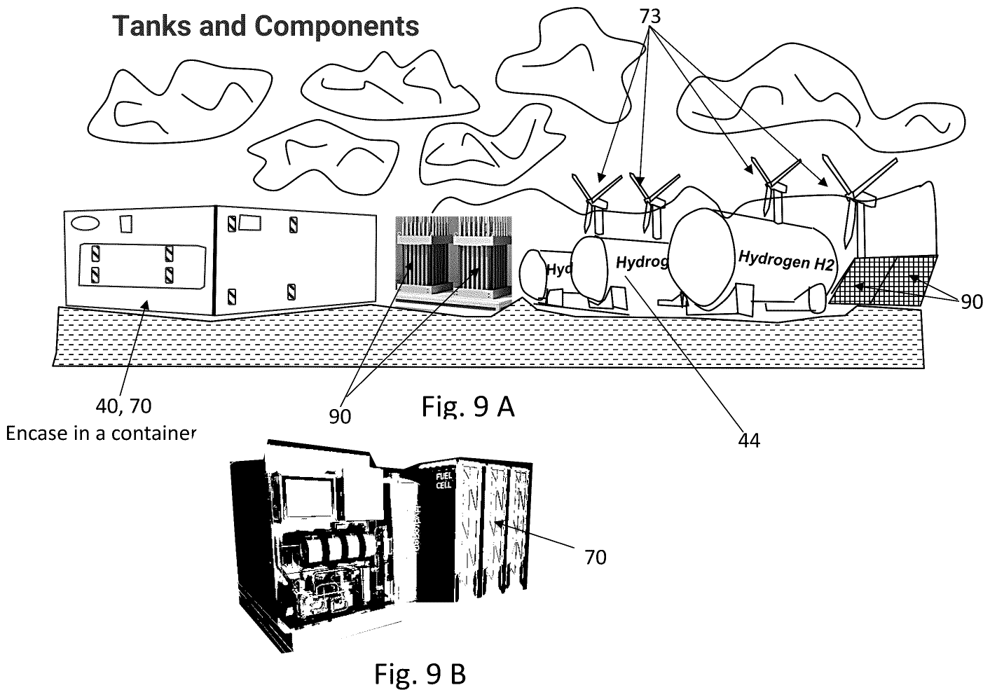

FIGS. 9 A and 9 B are sketches of the fuel cells 70 using hydrogen 42 as the source for renewable electricity. Shown are a hydrogen (H2) hydrolyzer, fuel cell, and/or electrolysis unit 40; a hydrogen storage tanks 44; a Fuel Cell 70; and a wind-based generator system 73. If hydrogen generators and hydrolyzers are local to the use point, one can reduce expensive storage costs. There is no need for specialized high-pressure storage tanks if the right amount of hydrogen is produced and fed into buffers ahead of the fuel cells at the time of need. This can reduce or eliminate the costs and logistical concerns inherent in distributing compressed hydrogen.

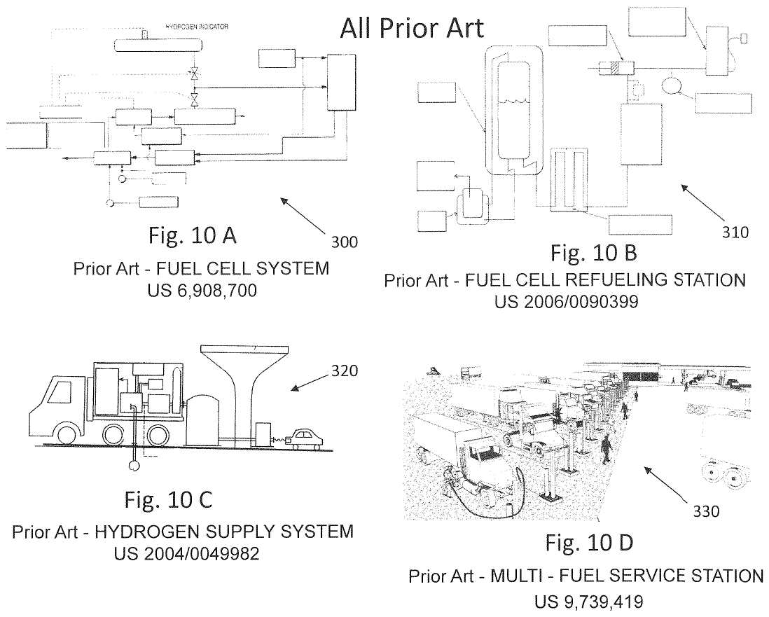

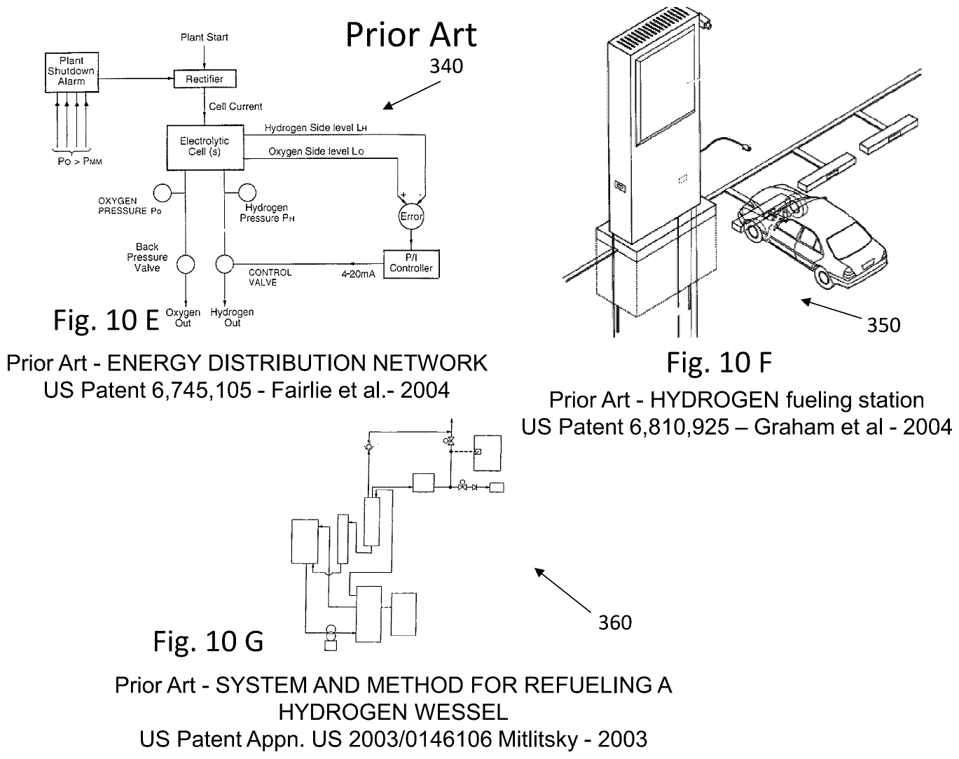

FIG. 10 A through 10 G are sketches of prior art. Here former patents and applications for various energy transformation systems and devices are shown. These include: prior Art 300 U.S. Pat. No. 6,908,700—2005—BY Iio—a FUEL CELL SYSTEM FOR VEHICLE; prior Art 310 Patent Application US 2006/0090399—2006 BY Wikstrom et al—a FUEL CELL REFUELLNG STATION AND SYSTEM; prior Art 320 Patent Application US 2004/0049982 by Shimizu et al—2004—a HYDROGEN SUPPLY SYSTEM AND MOBILE HYDROGEN PRODUCTION SYSTEM; prior Art 330 U.S. Pat. No. 9,739,419—Donnelly—2017—a MULTI-FUEL SERVICE STATION; prior Art 340 U.S. Pat. No. 6,745,105—Fairlie et al.—2004—an ENERGY DISTRIBUTION NETWORK; prior Art 350 U.S. Pat. No. 6,810,925—Graham et al—2004—HYDROGEN fueling station; and prior Art 360 US Patent Application US 2003/0146106 Mitlitsky—2003—a SYSTEM AND METHOD FOR REFUELLNG A HYDROGEN WESSEL. As can be seen, the Combination Power Replenishment System 30 for Off-Grid and 100% Carbon Free Re-fueling Station for HYDROGEN Vehicles and Re-Charging Station for Electric Vehicles.

The details mentioned here are exemplary and not limiting. Other specific components and manners specific to describing a Combination Power Replenishment System 30 for Off-Grid and 100% Carbon Free Re-fueling Station for HYDROGEN Vehicles and Re-Charging Station for Electric Vehicles may be added as a person having ordinary skill in the field of fuel cells, hydrolyzers, and electrolysis systems, devices and their uses well appreciates.

### OPERATION OF THE PREFERRED EMBODIMENT

The Combination Power Replenishment System 30 for Off-Grid and 100% Carbon Free Re-fueling Station for HYDROGEN Vehicles and Re-Charging Station for Electric Vehicles has been described in the above embodiment. The manner of how the device operates is described below. One notes well that the description above and the operation described here must be taken together to fully illustrate the concept of the Combination Power Replenishment System 30 for Off-Grid and 100% Carbon Free Re-fueling Station for HYDROGEN Vehicles and Re-Charging Station for Electric Vehicles. The preferred embodiment is A Combination Power Replenishment System 30 for Off-Grid and at least one hundred percent (100%) Carbon Free Re-fueling Station 30 for Hydrogen Vehicles 110 and Re-Charging Station 80 for Electric Vehicles (EV) which is comprised of: (a) a Hydrogen Electrolyzer 40 component; (b) a hydrogen fuel cell 70 component using materials such as methanol, ethanol, anhydrous ammonium, and the like etc. for obtaining hydrogen; (c) a flow battery 90 component using common host materials with water, the host materials coming from a host group of chemicals consisting of hydrogen rich chemicals [zinc-bromine, natural gas, alkaline fuel cell (AFC), Solid acid fuel cells (SAFCs), Phosphoric acid fuel cells (PAFCs), anhydrous ammonia, etc.] and water; (d) connection components including at least one Hydrogen storage tank 44, a hydrogen pump 50, a hydrogen compressor 55, and a group 46 of piping, valves, fixtures, and controls interconnecting the group of fixtures and the components of the system 30; (e) at least one hydrogen fueling pump distribution component 55; and (f) at least one electric vehicle (EV) charger port 80 wherein the Combination Power Replenishment System 30 is for an a Off-Grid, hydrogen-based re-fueling system 60 by a pump 55 and an at least one hundred percent (100%) Carbon Free hydrogen Re-fueling Station 80 and for HYDROGEN Vehicles and Re-Charging Station for Electric Vehicles (EV).

A hydrogen fuel cell changes energy stored in particles into power through an electrochemical response. A normal hydrogen fuel cell operates in the following way: (1) Hydrogen joins the fuel cell through the anode. Here, hydrogen particles respond with a compound and divide into electrons and protons. Oxygen from the ambient air arrives on the other side across the cathode. (2) The positive-assailed protons pass through the permeable electrolyte casing to the cathode. The negatively charged electrons stream out of the cell and make an electric flow, which can be used to drive an electric or hybrid-electric thrust system. (3) In the cathode, the protons and oxygen then mix to make H₂O. There are several things to know about hydrogen fuel cells, they are: Hydrogen is the most plentiful element on earth; Hydrogen fuel cells can be used to power numerous functions; Hydrogen is a clean way to produce water; vehicles with hydrogen fuel cells are very similar to gasoline-powered cars; and today California has more than 30 commercial hydrogen stations.

Many uses are anticipated for the Combination Power Replenishment System 30 for Off-Grid and 100% Carbon Free Re-fueling Station for HYDROGEN Vehicles and Re-Charging Station for Electric Vehicles. Some examples, and not limitations, are shown in the following Table. They are also used to power fuel cell vehicles, including forklifts, automobiles, buses, trains, boats, motorcycles, and submarines.

| ITEM | DESCRIPTION |
|---|---|
| 1 | Power hydrogen fuel cell on consumer vehicles such |
| | as automobiles, trucks, and boats. |
| 2 | Power hydrogen fuel cell on industrial vehicles like |
| | fork trucks, off the road construction equipment, and |
| | farm equipment |
| 3 | Power railroad engines |
| 4 | Power emergency response equipment |
| 5 | Power military and homeland defense equipment |
| 6 | Supplement off-grid electrical energy needs |
| 7 | Provide stationary source of off-grid electrical energy |
| | needs to neighborhoods, military posts, oil fields and |
| | remote mining locations, etc. |
| 8 | |

Uses specific to the Hydrogen Electrolyzer, it is a versatile technology that can be used for a variety of applications. Some of the most common uses include:
A. Hydrogen generation for fuel cell vehicles: Hydrogen fuel cell vehicles are becoming increasingly popular as a clean and sustainable alternative to traditional gasoline and diesel vehicles. The Hydrogen Electrolyzer can generate the hydrogen needed to power these vehicles.
B. Hydrogen generation for industrial processes: Hydrogen is used in many industrial processes, from refining oil to making fertilizer. The Hydrogen Electrolyzer can generate the hydrogen needed for these processes, providing a cost-effective and efficient solution.
c. Hydrogen water generation for drinking and other uses: The Hydrogen Electrolyzer can be used to generate hydrogen water, which is water that contains dissolved hydrogen gas. Hydrogen water has been shown to have many health benefits. It can be used for drinking, cooking, and even as a beauty product.
D. Hydrogen power generator for homes and businesses: The Hydrogen Electrolyzer can be used as a hydrogen power generator for homes and businesses. This means that it can generate electricity and heat, providing a clean and sustainable energy source for homes and businesses.

With this description it is to be understood that the Combination Power Replenishment System 30 for Off-Grid and 100% Carbon Free Re-fueling Station for HYDROGEN Vehicles and Re-Charging Station for Electric Vehicles is not to be limited to only the disclosed embodiment of product. The features of the Carbon Free Re-fueling System 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. A Combination Power Replenishment System (30) for Off-Grid and one hundred percent (100%) Carbon Free Re-fueling Station (30) for a Hydrogen Vehicle (110) which is comprised of:
(a) a Hydrogen Electrolyzer (40);
(b) a hydrogen fuel cell (70) component using hydrogen rich materials for obtaining hydrogen;
(c) a flow battery (90) component using water with a common host materials, the host materials coming from a host group of chemicals consisting of hydrogen rich chemicals;
(d) a combination of connection components including at least one Hydrogen storage tank (44), a hydrogen pump (50), a hydrogen compressor (55), and a group (46) of piping, valves, fixtures, and controls interconnecting the group of fixtures and the components of the system (30);
(e) at least one hydrogen fueling pump (55) for distribution to a hydrogen fueled vehicle (100); and
(f) at least one electric vehicle (EV) charger port (80) wherein the Combination Power Replenishment System (30) is for an a Off-Grid, hydrogen-based re-fueling system (60) by a pump (55) and an at least one hundred percent (100%) Carbon Free hydrogen Re-fueling Station (80) and for HYDROGEN Vehicles and Re-Charging Station for Electric Vehicles (EV).

2. The Combination Power Replenishment System (30) as described in claim 1 further comprised with a set of supplemental solar panels (66).

3. The Combination Power Replenishment System (30) as described in claim 2 wherein the supplemental solar panels (66) are selected from a group consisting of Photo voltaic solar panels and ultraviolet (UV) Thermal Solar Panels.

4. The Combination Power Replenishment System (30) as described in claim 3 wherein the Ultraviolet (UV) Thermal Solar Panels comprising:
(a) A set of solar thermal collectors (panels) on a roof, shade structure and/or other location which absorbs solar energy into a flow of water making a hot water;
(b) copper heating pipes transfer heat to a unit header and out of the set of thermal collector panel;
(c) a closed hydronic loop where the hot water is delivered to a heat exchanger for direct use and/or to a storage tank; and
(d) the solar-heated hot water is transferred to the end user through a conventional boiler and/or water heater for use.

5. The Combination Power Replenishment System (30) as described in claim 1 wherein the hydrogen rich materials for obtaining hydrogen from a hydrogen reformer is selected from a group consisting of methanol, ethanol, and anhydrous ammonium.

6. The Combination Power Replenishment System (30) as described in claim 1 wherein the host group of hydrogen rich chemicals for the flow battery (90) is selected from a group consisting of zinc-bromine, natural gas, alkaline fuel cell (AFC), Solid acid fuel cells (SAFCs), Phosphoric acid fuel cells (PAFCs), magnesium, sodium, and anhydrous ammonia.

7. A Combination Power Replenishment System (30) for Off-Grid and one hundred percent (100%) Carbon Free Re-fueling Station (30) for a Hydrogen Vehicle (110) comprising at least a one hundred percent (100%) Carbon Free Re-fueling Station (30) for Hydrogen Vehicles (110), a Re-Charging Station (80) for Electric Vehicles (EV), and a set of supplemental solar panels wherein the Combination Power Replenishment System (30) is for an a Off-Grid, hydrogen-based re-fueling system (60) for HYDROGEN Vehicles and the Re-Charging Station for Electric Vehicles (EV).

8. A Combination Power Replenishment System (30) for Off-Grid and one hundred percent (100%) Carbon Free Re-fueling Station (30) for a Hydrogen Vehicle (110) as described in claim 7 wherein the Re-Charging Station (80) for Electric Vehicles (EV) is comprised of at least one electric vehicle (EV) charger port.

9. A Combination Power Replenishment System (30) for Off-Grid and one hundred percent (100%) Carbon Free Re-fueling Station (30) for a Hydrogen Vehicle (110) as described in claim 7 further comprised with a set of supplemental solar panels (66).

10. Combination Power Replenishment System (30) for Off-Grid and one hundred percent (100%) Carbon Free Re-fueling Station (30) for a Hydrogen Vehicle (110) as described in claim 9 wherein the set of supplemental solar panels (66) are selected from a group consisting of Photo voltaic solar panels and ultra violet (UV) Thermal Solar Panels.

11. The Combination Power Replenishment System (30) as described in claim 10 wherein the Ultraviolet (UV) Thermal Solar Panels comprising:
(a) A set of solar thermal collectors (panels) on a roof, shade structure and/or other location which absorbs solar energy into a flow of water making a hot water;
(b) copper heating pipes transfer heat to a unit header and out of the set of thermal collector panel;
(c) a closed hydronic loop where the hot water is delivered to a heat exchanger for direct use and/or to a storage tank; and
(d) the solar-heated hot water is transferred to the end user through a conventional boiler and/or water heater for use.

12. The Combination Power Replenishment System (30) as described in claim 7 wherein the one hundred percent (100%) Carbon Free Re-fueling Station (30) for Hydrogen Vehicles (110) is selected from the group consisting of where
(a) Hydrogen is produced in large quantities at a factory transported to a hydrogen supply station in a form of liquefied hydrogen or high-pressure hydrogen by using a tank lorry;
(b) Hydrogen is produced in large quantities at a factory and is transported to hydrogen supply stations with a pipeline; and
(c) Hydrogen is produced by a hydrogen reformer/fueling station by water-vapor reforming a hydrogen rich material
wherein the Combination Power Replenishment System (30) is for an a Off-Grid, hydrogen-based re-fueling system (60) by a pump (55) and an at least one hundred percent (100%) Carbon Free hydrogen Re-fueling Station (80) and for HYDROGEN Vehicles and Re-Charging Station for Electric Vehicles (EV).

13. The Combination Power Replenishment System (30) as described in claim 12 wherein the Carbon Free reformer Station (30) for a Hydrogen Vehicle (110) which is comprised of:
(a) a Hydrogen Electrolyzer (40);
(b) a hydrogen fuel cell (70) component using hydrogen rich materials for obtaining hydrogen;
(c) a flow battery (90) component using water with a common host materials, the host materials coming from a host group of chemicals;
(d) a combination of connection components including at least one Hydrogen storage tank (44), a hydrogen pump (50), a hydrogen compressor (55), and a group (46) of piping, valves, fixtures, and controls interconnecting the group of fixtures and the components of the system (30);
(e) at least one hydrogen fueling pump (55) for distribution to a hydrogen fueled vehicle (100); and
(f) at least one electric vehicle (EV) charger port (80)
wherein the Combination Power Replenishment System (30) is for an a Off-Grid, hydrogen-based re-fueling system (60) by a pump (55) and an at least one hundred percent (100%) Carbon Free hydrogen Re-fueling Station (80) and for HYDROGEN Vehicles and Re-Charging Station for Electric Vehicles (EV).

14. The Combination Power Replenishment System (30) as described in claim 13 wherein the hydrogen rich materials for obtaining hydrogen from a hydrogen reformer is selected from a group consisting of methanol, ethanol, and anhydrous ammonium.

15. The Combination Power Replenishment System (30) as described in claim 13 wherein the host group of hydrogen rich chemicals for the flow battery (90) is selected from a group consisting of zinc-bromine, natural gas, alkaline fuel cell (AFC), Solid acid fuel cells (SAFCs), Phosphoric acid fuel cells (PAFCs), magnesium, sodium, and anhydrous ammonia.

16. A Combination Power Replenishment System (30) for Off-Grid and one hundred percent (100%) Carbon Free Re-fueling Station (30) for a Hydrogen Vehicle (110) comprising at least a one hundred percent (100%) Carbon Free Re-fueling Station (30) for Hydrogen Vehicles (110), a Re-Charging Station (80) for Electric Vehicles (EV), and a set of supplemental solar panels
wherein a reformer Station (30) for a Hydrogen Vehicle (110) which is comprised of:
(a) a Hydrogen Electrolyzer (40);
(b) a hydrogen fuel cell (70) component using hydrogen rich materials for obtaining hydrogen;
(c) a flow battery (90) component using water with a common host materials, the host materials coming from a host group of chemicals consisting of hydrogen rich chemicals;
(d) a combination of connection components including at least one Hydrogen storage tank (44), a hydrogen pump (50), a hydrogen compressor (55), and a group (46) of piping, valves, fixtures, and controls interconnecting the group of fixtures and the components of the system (30); and
(e) at least one hydrogen fueling pump (55) for distribution to a hydrogen fueled vehicle (100);
wherein there is at least one electric vehicle (EV) charger port (80); and
wherein there is a set of supplemental solar panels (66) wherein the Combination Power Replenishment System (30) is for an a Off-Grid, hydrogen-based re-fueling system (60) by a pump (55) and an at least one hundred percent (100%) Carbon Free hydrogen Re-fueling Station (80) for HYDROGEN Vehicles and Re-Charging Station for Electric Vehicles (EV).
